(19) United States
(12) Patent Application Publication
(10) Pub. No.: US 2008/0285700 A1
(43) Pub. Date: Nov. 20, 2008

(54) Supercell Communications and Energy Generator

(76) Inventor: Carolyn Davis, Gosford (AU)

Correspondence Address: Carolyn Davis, 46 Carolina Park Rd, Avoca Beach, Gosford, 2251, AU

(21) Appl. No.: 11/746,675

(22) Filed: May 15, 2007

(51) Int. Cl. H05H 1/12

(52) U.S. Cl. 376/137

(57) ABSTRACT

A stellarator made of magnetic material containing nuclear fused gases with plasma the result and magnetic helical coils around stellarator. This is not a vacuum.

The driving power source for this invention is the electromagnetic waves. Electromagnetic radiation is resulted into a laser light beam due to total reflection from three planar mirrors arranged at right angles and clear quartz crystal deformed into the optical shape meniscus concave and the focal point of crystal are where the beams are focused and highly concentrated into a piercing glow of light and the crystal has then naturally formed the laser light beam and laser beam is then virtually beamed through spherical concave mirrors focal point and laser light beam ignites Co2 and neon plasma.

Infinite wave is formed by unique frequency and shape of clear quartz crystal and its optical properties. And the 12 o'clock midday sun.

### CROSS-REFERENCE TO RELATED APPLICATIONS

There are gaps in the world program for stellarators.

The non-US stellarators, including smaller experiments, have plasma aspect ratios ranging from 5 to 11 and extrapolate, to very large reactors, low aspect ratios (less than 5) are unexplored.

The large non-US stellarator programs will extend stellarator research to new levels of size and performance but will not cover the full range of issues important for compact stellarator development.

The most common nuclear fusion is the reaction of 2 nuclei of the two heavy forms (isotopes) of hydrogen-deuterium (D) and tritium (T). Deuterium occurs naturally in sea water. Tritium does not occur naturally and is radioactive and only has a half life of 12 years. Tritium has to be made in a nuclear reactor, bred in a fusion system with lithium.

There are concerns about the release of tritium into the environment. It is radioactive and very difficult to contain. As an isotope of hydrogen it is easily incorporated in water, making the water itself weakly radioactive. With a half life of 12 years tritium remains a threat to health for over one hundred years after it is created, as a gas or in liquid. It can be inhaled, absorbed through the skin or ingested.

There would be short term radioactive waste problem due to activation products. Some component materials will become radioactive during the lifetime of the reactor and will eventually become radioactive waste.

There are also concerns hazards arising from an accident to the magnetic system. The total energy stored in the magnetic field would be similar to that of an average lightning bolt and maybe a lithium fire.

In contact with air and water lithium burns spontaneously and could release many times that amount of energy.

There are currently no stellarators existing that operate efficiently enough to be commercially viable nor cost effective to run.

The stellarators have difficulties currently, be it choice of gases nuclear fused, choice of chemical elements used in stellarator or the expense in the process of powering them.

The Supercell stellarator runs at ambient temperature with safe gases used for nuclear fusion and the chemical elements used in stellarator are the strong magnet.

A number of reactor designs use toroidally-shaped (donut-shaped) confinement arrangements for the reactor, or variations on a toroidally-shaped reactor. These include:

Standard Tokamak Fusion: Tokamak fusion reactor designs contain the fusion fuel plasma in a toroidally-shaped electromagnetic containment field. These designs have been able to contain plasmas for extended periods of time, reach high temperatures and develop high densities.

Spherical Tokamak Fusion: The cross section of a normal Tokamak is circular. The cross-section of a “spherical” Tokamak is more elongated in the vertical direction.

Stellarators: In general, there is little difference between Tokamaks and Stellarators—they are both toroidal. The orbit of plasma in a Tokamak is planar—i.e., there is no vertical motion. The orbit of plasma in some Stellarator designs is non-planar—i.e., there is vertical motion.

Field Reversed Configuration (FRC): The Field Reversed Configuration is another toroidal system with magnetic field lines arranged differently.

Reversed-Field Pinch (RFP): Reversed-Field Pinch devices are similar to a Tokamak in that the plasma is confined by both toroidal and poloidal magnetic fields. The main difference is the relative strength of the magnetic fields.

Some of the earliest devices for creating high-temperature plasmas used cylindrical patterns. These designs included:

Theta Pinch Theta Pinch designs take the form of a long tube or a skinny torus. The Theta Pinch uses an electrically induced magnetic field to compress and heat the plasma.

Z-pinch: The idea of the Z-Pinch, best embodied in Sandia National Laboratory's Z-Pinch device, is to suddenly apply a massive voltage across a cylindrical pattern of cables, causing the cables to vaporize. The cross-product of the Electric and Magnetic fields produced, described using the Poynting Vector, or classically as the Electromagnetic Momentum, of the induced fields, collapses the plasma in a cylindrical pattern.

Mirror Machines: A Mirror Machine operates essentially like a Theta Pinch except a strong magnet is placed around each end of the tube in an attempt to deflect the plasma backwards towards the opposite end of the tube.

None of the aforementioned devices have successfully reached the ultimate goal of achieving a commercially viable source of energy using nuclear fusion for mankind's energy sources.

As claimed by another inventor Seelert more than one resonator is required to generate green and red light from plane polarized blue light through two resonators each having praseodymium-doped gain medium. In this invention the laser light beam is formed with the joining of the sound wave which is formed by the clear quartz crystal and the extracted wave including laser light beam is the singular wave being infinite wave. In this invention there is one resonator that is the clear quartz crystal and only one crystal is used along with planar mirrors positioned exactly to capture every electromagnetic wave perfectly and the mirrors hone and focus the light beams of radiation into the focal point of crystal and it vibrates outwards due to the spreading wavelet theory and holds its formation of a spherical sound wave and also spherical light wave with a twist in the centre due to the centre of crystal being the highest point of vibration of the crystal and forms a twist in the centre of the spherical wave and this twist hold and compresses the two waves being laser light wave and sound wave forming perfect infinite wave and the natural formation of the polarized light in my invention is firstly white light focused with full intensity split into electromagnetic spectrum whilst spreading over surface of the crystal and then refocusing onto plane polarized surface of crystal and is compressed then with sound wave vibration which also takes on the exact same form and shape as the newly formed white polarized light thus to form one wave namely infinite due to its perfect shape of infinite. The extracted light beam is a laser light beam with extreme intensity and singular wave length then due to the joining of the sound waves to form one wave with claimed name of infinite wave and the frequency of this beam is described in my theory of the infinite wave

### BACKGROUND OF INVENTION

1. Field of the Invention

The largest machines for the magnetic confinement of plasmas are stellarators. Stellarators are toroidal devices in which the electrical current in the plasma is produced entirely by the pressure gradient. Other toroidal devices for confining plasmas, such as the tokamak, require a current, the driven current, in addition to that produced by the plasma pressure. The driven current has two associated problems, the excessive amount of power required to maintain it and instabilities, such as the major disruption of tokamaks.

2. Description of Related Art

The most common problems in past nuclear fusion reactor designs are the instabilities in the plasma, where in the current invention this is eliminated by the wrapping of the helical coils around the stellarator. The plasma is maintained at ambient temperature whereby to avoid plasma drift and instabilities, where to date all other experiments are superconducting at extremely high temperatures. Seelert invention claims to produce white light from more than one resonator and by producing and reproducing white light. This is a complex formation and the due to many steps to achieve the white light laser it varies in intensity where it would be more advantageous to combine full intensity laser light beam with sound wave vibration to form one singular laser light beam infinite wave that carries infinite communications and energy.

Nuclear fusion is a much more viable alternative to nuclear fission reactions as there is a 1000 times more radioactive waste using nuclear fission.

### BRIEF SUMMARY OF INVENTION

The electromagnetic spectrum (radiation) is perfectly complete and perfectly captured in this invention and is the driving power source. The electromagnetic radiation is focused and intensified by the use of the crystal and optical apparatus, being the mirrors, though it is altered in direction through manipulation of optical apparatus by the positioning of the mirrors and crystal. The Supercell Energy Generator is a stellarator. It is made of stainless steel because of its tensile strength, the alnico group, comprising of aluminium, nickel and cobalt melted down and fused together (which is an extremely powerful magnet) and it has silver on the interior so as to reflect 95% of the laser light. Superconductivity is produced due to magnetic properties of alnico group and the current is the laser light beam passing through it and silver on the interior lining of stellarator tube to reflect 95% of the laser light beam back onto itself permanently causing complete stability and energy of plasma. There are a number of helical coils around stellarator to confine plasma and remove spent fuel

The Supercell contains plasma, which is the result of two nuclear fused gases that are CO2 and Neon. The use of CO2 makes it capable of superconducting at ambient temperature at all times. These gases were used because firstly CO2 is the cooling effect on the system and it absorbs atmospheric air, it also prevents oxidation of the metals used in the stellarator. CO2 is also easily absorbed so this property will make it easy to nuclear fuse. Neon was used because of its dielectric cohesion being 6.3 which is the lowest of any gas, meaning an electric current can flow through it and it emits the light as a glowing effect. The physical properties of these two gases prove that they are fusible. (See Paragraph—Neon, Carbon and Oxygen in Description Section). It is further explained why these chemical elements were chosen for fusion with relation to hydrogen and then the natural fusion of helium, then by products from that fusion, in relation to the beginning of the universe in its natural course of creation. The by products of the earliest helium fusion being Neon, Carbon and Oxygen all contain the same energy produced from that first helium fusion and these chemical elements, neon, carbon and oxygen created earth. The chemical elements are scientifically proven in the nature of the universe to be a perfect fusion for earth's energy. The energy of these elements are perfect in our atmosphere in there natural state. Perfectly matched atomic numbers for fusion and the energy and natural occurrence of relevance to the big bang and the second chemical element produced from that, being helium, formed energy that created life. To fuse neon, carbon and oxygen back together would be the first and only natural fusion for perfect ambient temperature plasma. That energy is pure and to be a natural resource for earth. It is simple and it just is. This is a further theory belonging to me and I can prove it.

The optical apparatus was used because it catches and reflects totally the electromagnetic waves and refraction into focal point of crystal forms a laser light beam.

This stellarator is not a vacuum, therefore the electromagnetic waves under this law of theory travels at the speed of infinite, due to optical shape of clear quartz crystal and Hooke's Law being stress=C×Strain. It has been theorised that a medium can alter the wave speed of electromagnetic waves. The theory in this invention (See Infinite Wave Theory) explains in theory how the electromagnetic waves change the natural wave speed, being the speed of light when in unbound space and by using a medium which is universally used to control and alter wave speed into infinite wave speed by using a unique optical shaped surface of crystal being meniscus concave turned upside down to have a convex surface and this also manipulates a single frequency, converting multiple frequencies of electromagnetic waves into one single unique frequency described in (theory infinite wave) which describes infinite wave and its characteristics. This is explained. The infinite wave through its unique frequency and shape of surface of crystal, (See FIG. 3) whereby the vibration of this crystal because of it's unique shape spreads the sound wave and light quanta and particles, obeying wave particle duality theory, in the electromagnetic waves to outer perimeters of spherical surface of crystal and all of the waves, sound and electromagnetic, form one wave in the shape of infinite with one wavelength, one wave speed, being infinite wave speed, and is visibly seen as all light quanta and particles vibrate within the electromagnetic waves all are transformed into one frequency and one wave. The sound waves are the vibration, containing the communications and it is the sound waves vibrating across the curtain of the clear quartz crystal and in unison with the natural frequency of the clear quartz crystal, which is verified to be a reliable pulsing natural vibration. The vibration (frequency) of the spherical sound wave manipulated by the natural unique frequency of crystal and shape of surface of crystal naturally forms the shape in the infinite wave being ∞. It starts as a circle the spherical wave being the shape [symbol] then the centre of circle forms a twist and results in the wave shape ∞. (See FIG. 3). The infinite wave is in the form of a laser light beam which is spatially coherent and all light waves radiate singularly as a single wave and single wavelength and singular wave speed being infinite. Also with infinite energy and communications due to properties of the infinite wave and laser light beam carrying thousands of communications simultaneously

### BRIEF DESCRIPTION OF THE SEVERAL VIEWS OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 schematically illustrates one preferred embodiment of a stellarator consisting of 3 planar mirrors carefully arranged above meniscus concave reversed clear quartz crystal that produces a laser light beam through crystal and through spherical concave mirror positioned underneath crystal and beams down into centre tube of stellarator and around torus of stellarator igniting internal nuclear fused carbon, oxygen and neon plasma and due to the magnetic alnico group stainless steel and silver which the stellarator comprises of the laser light beam is superconducting and is energy is extracted via infinite wave energy and then is conducting via copper wire into autotransformer whereby it is split into two loads of energy leg one of autotransformer is via copper wire and transferred into jfet transistor and leg two of autotransformer is transferred into transducer whereby energy is converted back into soundwaves for communications and is released into nmos transistor with waffle transistors attached to it and the two transistors act like switches.

FIG. 2 schematically illustrates the use of 3 planar mirrors and how in this invention the electromagnetic radiation totally reflects due to the angle of incidence of rays exceeds the critical angle causing total reflection and all rays refract into focal point of crystal which is in the shape of reversed meniscus concave and a focus of piercing laser light beam is formed and beams straight through focal point of spherical concave mirror which is butted up and underneath clear quartz crystal and into tube of stellarator igniting plasma.

FIG. 3 schematic illustration of surface of clear quartz crystal and shows how the infinite wave is formed and how due to the electromagnetic waves and sound waves vibrate out and across the crystalline curtain and the focal point of crystal being the highest point of vibration and this is where the spherical wave twist and binds all electromagnetic waves and sound wave together to form one singular wave being the infinite wave.

FIG. 4 schematically illustrated inside view of stellarator tube being made up of three layers, firstly stainless steel on the exterior layer, inside layer alnico group being a strong magnet, and inside layer silver to reflect 95% of the laser light beam.

FIG. 5 schematically illustrates inside of stellarator tube and how the silver is used to reflect the laser light beam back onto itself, being the constant reflecting and enhancing of already powerful laser light beam, and centre tube is filled with lasing plasma, nuclear fused neon, oxygen and carbon.

FIG. 6 schematically illustrates torus of stellarator and helical coils wrapped around it at 30 cm intervals.

FIG. 7 schematically illustrates side view of helical coils made of alnico group as magnetic stabilisers of plasma and hold plasma in position.

FIG. 8 schematically illustrates front view of helical coils and specific dimensions being inner wall of coils being 5.4 cm diameter and overall diameter of outer walls and stellarator being 40.8 cm.

FIG. 9 optically shows the side view of planar mirror and how rays naturally reflect off the planar mirrors where the incident ray and reflected ray is perfectly equal in the angle of reflection as opposed to in this invention the angle of incidence exceeds the critical angle causing total reflection.

FIG. 10 further shows how rays reflect off vertical planar mirror.

FIG. 11 illustrates a spherical concave mirror sideview of rays normally reflecting off mirror as a real image whereas in this invention the image being the laser light beam goes virtually through the focal point of spherical concave mirror.

### SUMMARY OF INVENTION

The present invention discloses a unique method of creating an energy generator which has the capability for commercially supplying the world with clean, pure energy and an infinite supply of energy.

The energy generator is also conducive to all weather types and with it also being solar powered, this is unique in itself. It is inexpensive capturing of solar energy and does not rely on constant sunlight. In fact one day of midday sunlight is enough to ignite plasma and flows continuously superconducting the electromagnetic waves.

The laser contains light quanta in the form of energy. The difference between the atoms which absorb the light and the density and strength of the light emitted is uniform with each atom in phase, which is transformed into one single phase for all light quanta in all electromagnetic waves. Therefore all light quanta within waves and all atoms are of the one singular phase and frequency, never to be altered. One singular uniform frequency of all light quanta are in the same phase and frequency with all atoms and that is why the laser is used for the supreme advantage of emitting its own light using quanta, energy and atoms which are all contained in electromagnetic waves and the sheer force and power of this light as a result. Wave particle duality is relevant to this theory. A laser if concentrated in our atmosphere would form as lightning bolts or electromagnetic waves with light quanta in phase with each wave and frequency of wave as in rainbows. Light is seen everywhere in our atmosphere as natural occurrence and at times as a random occurrence, as in lightning. With all this power of the light it has been used in concentrated form in this invention and with the added use and focus of the clear quartz crystal the laser beam is the most powerful energy filled laser light beam known to man. The communications contained in this laser light beam are so perfect that you could communicate throughout the universe with its universal communications in transmitting and receiving of communications through the infinite wave. Infinite universal communications. See Claim 10.

The present invention relies on the properties of gases used to nuclear fuse rather than lighter gases being deuterium and tritium until the nuclei are nuclear fusion and there is plasma burn. The previous fusions rely on fusion burn to extract energy, whereas in the present invention the result of the nuclear fusion of gases neon and co2 results in plasma at ambient temperature. These gases are a perfect fusion of atoms due to all three components adding up to equal atomic numbers and subatomic numbers. The atomic number for neon is 10 so therefore there is one neon atom and one carbon atom being atomic number 6 10+6=16 fused with two oxygen atoms oxygen being atomic number 8×2=16. A perfect match for fusion. See Claim no. 2.

The physics is unique as it goes with the laws of nature and this is verification alone that it works, being neon, oxygen and carbon which are the by products of the earliest helium fusion and are the most abundant chemical elements after hydrogen and helium and are necessary for life. These three chemical elements are the most abundant and created life on earth used in this invention for fusion and therefore the natural progression is fusion back together as they are all initially derived from the by product of helium fusion and are closely compatible. Due to all three chemical elements being an end result of helium fusion and closely linked together to create life it is a natural progression for these chemical elements to be used for fusion. The result of chemical elements used in this invention for fusion there could be nil radioactive waste due to the elements making up nature therefore environmentally friendly. The fusion products created by the first stellar generation prepared the universe for life by creating carbon and oxygen. Refer Claim 2.

Also there are many distinct problems with plasma burn being instabilities and inconsistencies in plasma, plasma drift, a reliance on keeping plasma burning, by use of an external electromagnetic field. In the past there has been no design for fusion reactors that places spherical electromagnetic fields around the fusion burn in order to impart energy to the fuel, to contain and ignite the fuel, and to extract energy from the fusion burn using MHD. MTF devices do not attempt to create a prolonged burn, instead they are explosively imploded The MAGO does not contain and prolong and sustain fusion burn. Z-Pinch devices have made little attempt to actively contain the fusion burn after implosion.

Supercell energy generator is a significant breakthrough in science and technology. Physics is a major element of this invention.

In the present invention steel is used on the exterior layer of stellarator due to its tensile strength and ability to resist corrosion. The alnico group was used because of its extreme advantage of being a powerful magnet and silver used due to its reflection properties of light. The length of the stellarator is large being 1 km in length and bent into the shape of torus so the electromagnetic laser is free flowing around stellarator. Refer Claim 6. The dimensions of this invention are of the utmost importance for its operation.

The helical coils used and also made of the alnico group are to confine plasma and as the plasma is at ambient temperature this will be an easy confinement. The drift should be minimal if any. The coils also act to remove any spent fuel though there should be no nuclear waste because of the co2 absorption properties. In other experiments integrated coils have been used, modular coils, discrete coils and current sheet coils. These all have their characteristic problems, current sheet coils being numerous difficulties are associated with ill-conditioning of the inductance equations which relate the Fourier components of the current potential to the normal component of the magnetic field at the plasma boundary. Modular coils magnetic field errors for a reasonable number of coils are simply too large. Instabilities of plasma and plasma drift are common from the use of these coils.

### DESCRIPTION OF INVENTION

### Detailed Description of the Preferred Embodiments

### Overall Layout

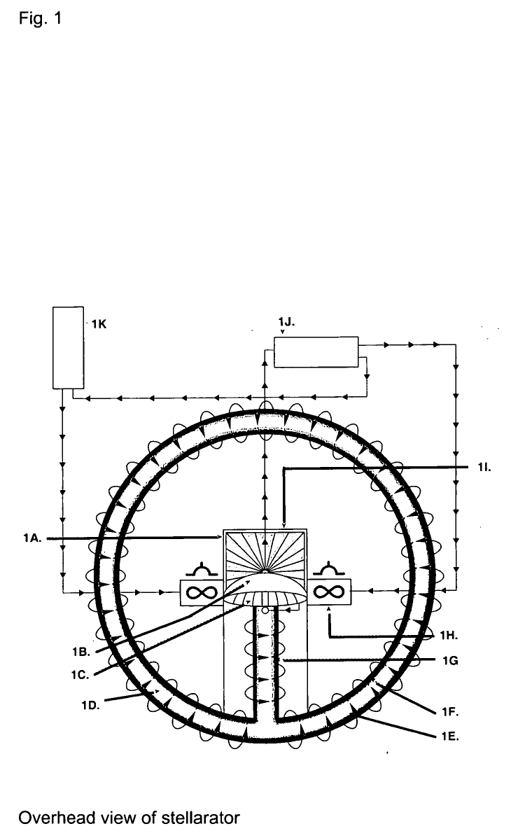

Refer to FIG. 1, which is an overall drawing of the preferred embodiment of the present invention. It has a stellarator with centre tube (FIG. 1G) and 313 helical conductors (FIG. 1E) 3 planar mirrors (FIG. 1A), a spherical concave mirror (FIG. 1C), a solar collector plate (FIG. 1I), a quartz crystal (FIG. 1B), an autotransformer (FIG. 1J), jfet field effect transistor (FIG. 1H), transducer (FIG. 1K), nmos transistor (FIG. 1K) laid out around toroidal stellarator.

### The Stellarator

The stellarator is a hollow tube, 1 km in length, with three layers of metals and bent into the shape of torus, meaning circular. The outer layer is stainless steel due to its strength and resists corrosion in all weather, then alnico group is the middle layer, which comprises of aluminium, cobalt and nickel melted down and is used because it is an extremely powerful magnet, and interior layer is made of silver due to silver reflecting 95% of light when in its natural state. There is a centre tube positioned just below centre of interior area inside the torus and joined to bottom inside wall of stellarator and is welded to stellarator with an opening the size of the end of the tube so as to form a perfect join so plasma is uninterrupted and in cavity of tube and internal cavity of stellarator is completely filled with plasma.

The dimensions for the preferred embodiment of stellarator are outer diameter of 30 cm with an outer layer of stainless steel 1.5 cm thickness, middle layer of alnico group 3 cm thickness and interior layer silver 1.5 cm thickness. The interior is filled with plasma. The layers of stellarator should be polished and smooth and joined perfectly together by either welding or melted together though not so much to penetrate interior of surface of next layer. Layers are butted up together so there is no movement between these layers. The materials need to be consistent and smooth for optimum superconductivity and electromagnetic harmonics.

### DESCRIPTION

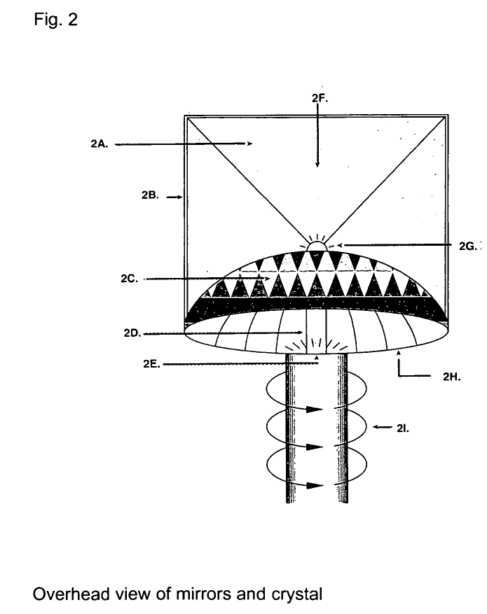

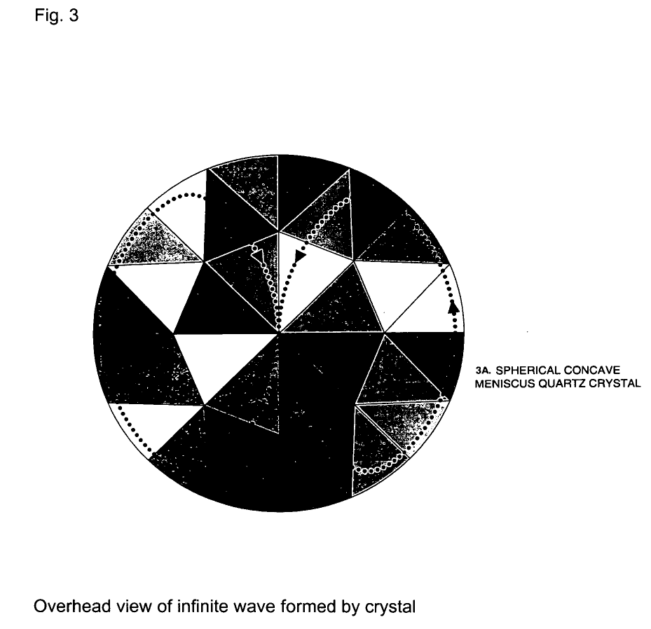

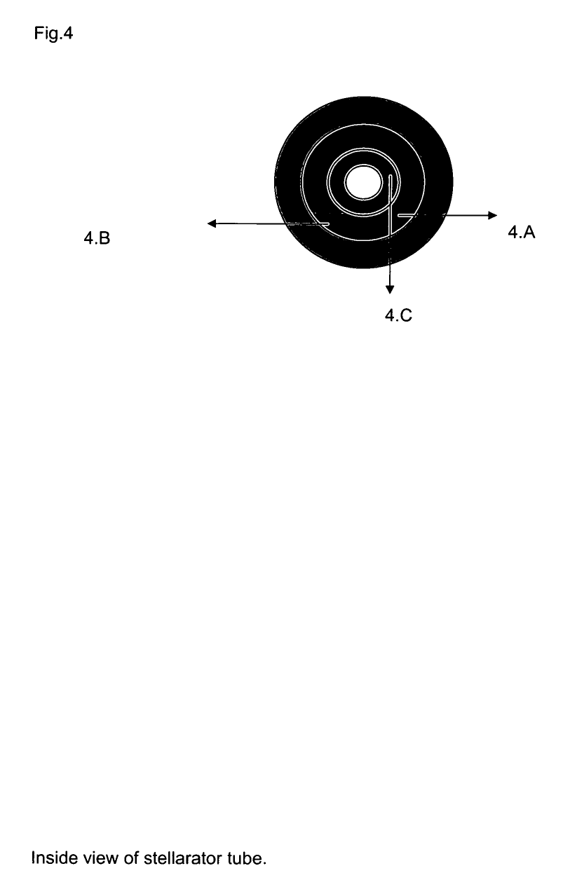

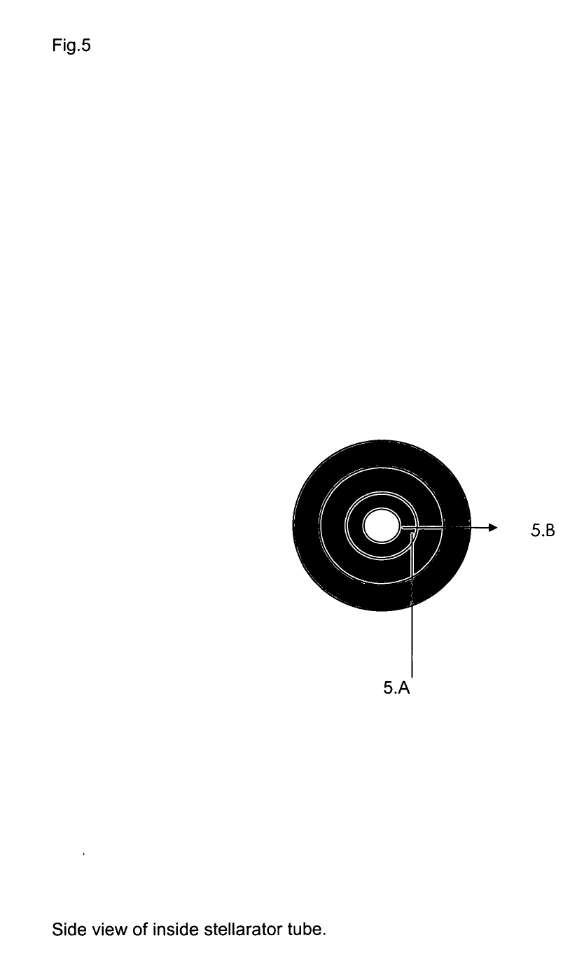

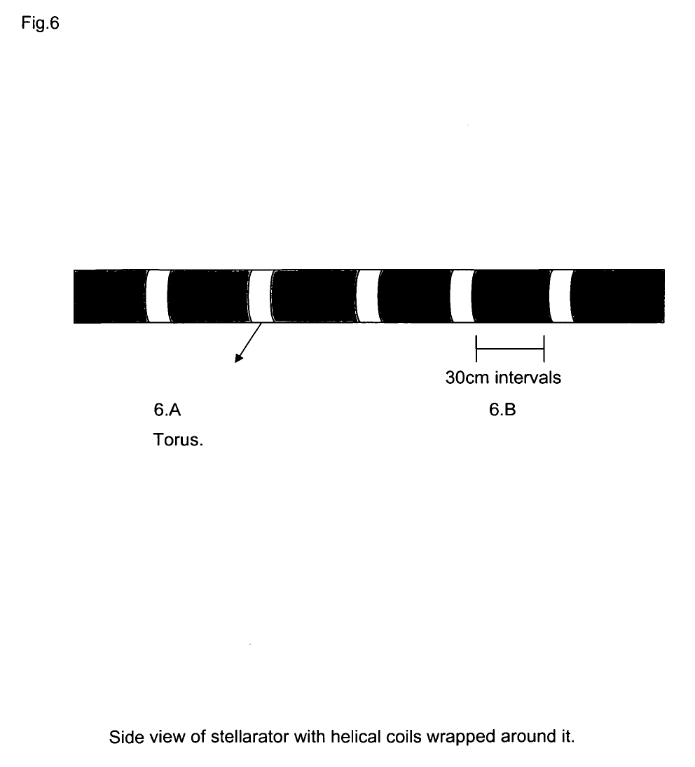

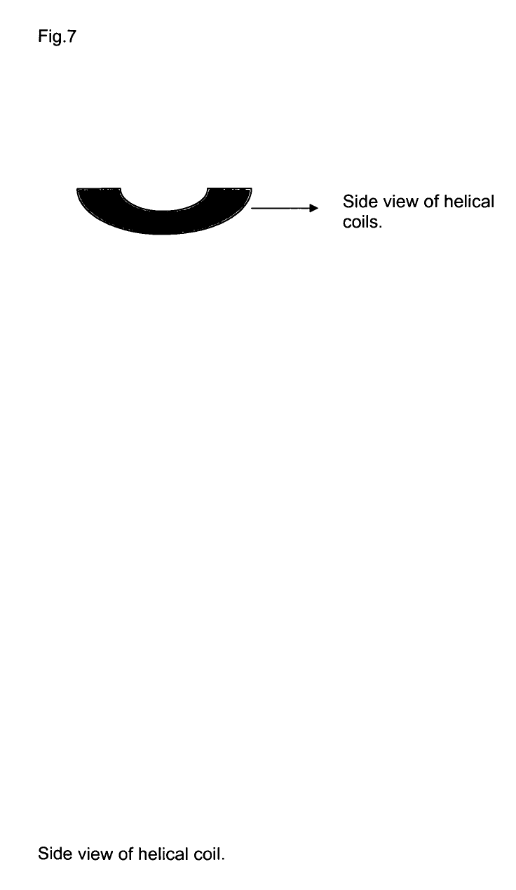

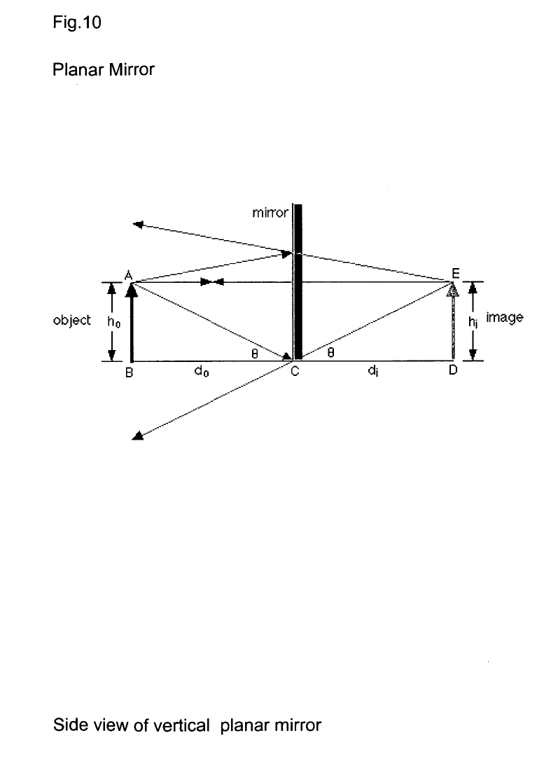

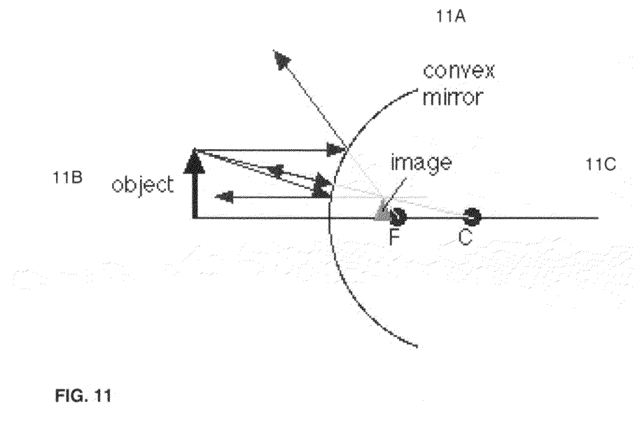

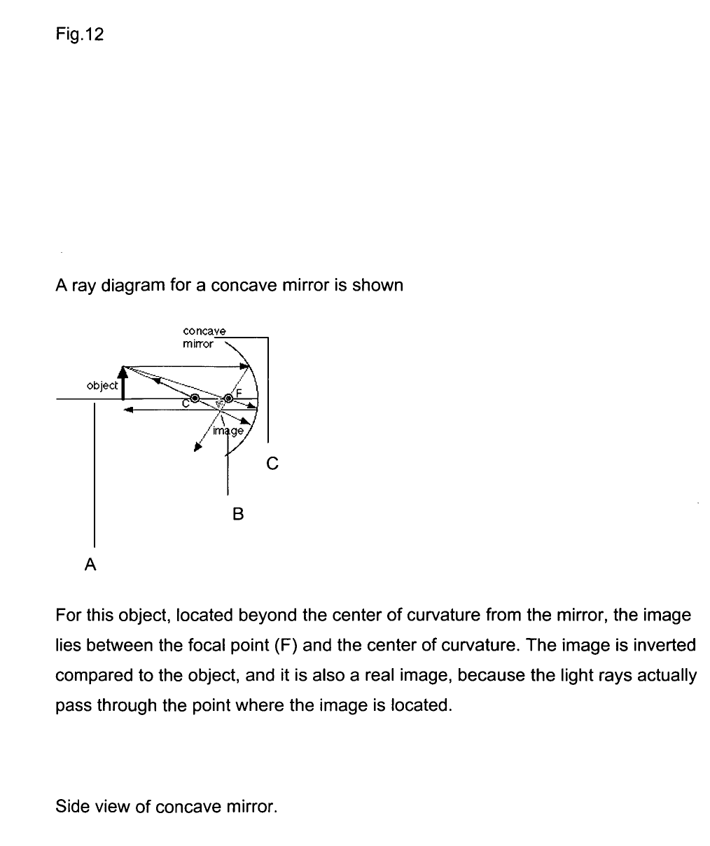

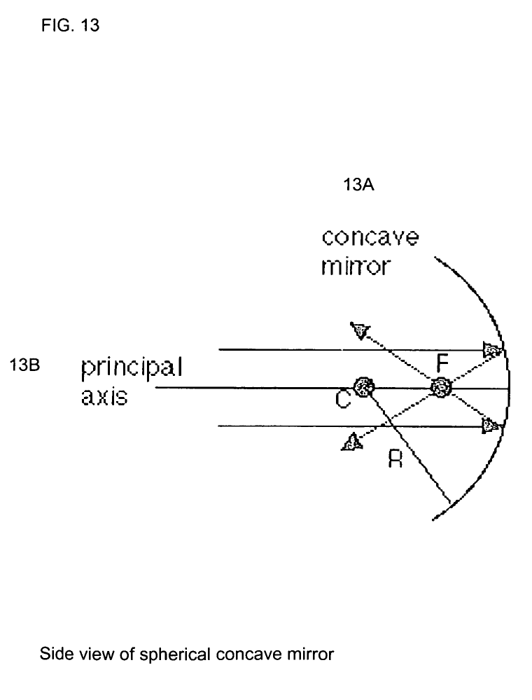

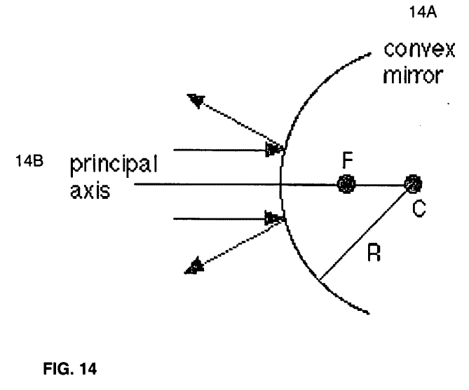

Inside view of Stellarator tube (See FIG. 4) embodiment which is toroidal made of stainless steel on the exterior, which is 1.5 cm thickness (See FIG. 4.A) then the next layer is the alnico group, which is 3 cm thickness (See FIG. 4.B) with silver on the interior layer 1.5 cm thickness (See FIG. 4.C). The combination of three metals provides a superconductive material to pass the electromagnetic beam through. Stainless steel because of its high tensile properties, silver lined interior, this intensifies beam by up to 95%, alnico metal due to its magnetic properties and filled with nuclear fused gases being neon and co2, to the ratio of 50:50, which plasma is the result (See FIG. 1.D). The plasma is CO2 which makes it capable of superconducting at ambient temperature and Neon due to its dielectric cohesion being 6.3 allowing electric current to flow through. Inside view of the torus of stellarator tube is hollow and the diameter is 30 cm (See FIG. 5.A). The internal cavity measures 18 cm in diameter (See FIG. 5.B). The embodiment of helical coils is there are approximately 313 helical coils, also made of the alnico group and 1.8 cm in thickness. (See FIG. 6.A) around the stellarator at exact intervals of 30 cm apart (See FIG. 6.B) and are uniform around the stellarator to purify and confine plasma and remove spent fuel. A side view of helical coils Alnico group walls 18 mm thickness solid rings helical coils (See FIG. 7). Overhead view of the three planar mirrors, (See FIG. 1A) each 1 sqm in area and an overhead view of spherical concave mirror, (See FIG. 1.C) 1 m in diameter, and an overhead view of a clear quartz crystal (See FIG. 1.B) 1 m in diameter and in the shape of meniscus concave. Overhead view of quartz crystal (See FIG. 3) which is the view of the sound wave vibration where stress=C×strain. The elastic behaviour is caused by the deformation of the quartz crystal called Piezo-electric Qualities and the wave is called an Infinite Wave. This wave is formed due to the shape of this crystal and crystal activity and the unique crystal vibration, being its frequency (See FIG. 3.A) Side view of optical shape meniscus concave reversed in this invention to have convex surface (See FIG. 14) optics. Overhead view of the 3 planar mirrors (See FIG. 1.A) is positioned in the shape of a u and the overhead views of crystal are positioned beneath three planar mirrors (See FIG. 1.B) and upside down and on top of spherical concave mirror (See FIG. 1.C) so as to form the shape of oval. (See FIG. 1.B) Overhead view of the solar collector plate (See FIG. 1.A) underneath u shaped planar mirrors and it is 1 sqm metre in area. The laser light beam (See FIG. 2.D) administered is directly from concentrated electromagnetic radiant energy from the sun and due to the positioning of the optical apparatus, which forms a focus of this laser light beam (FIG. 2.G) and refracts it down and into the centre tube (See FIG. 2.G). An overhead view of the reflection of light off a planar mirror (See FIG. 2.A, F) and (See FIG. 10) which shows where the object is, as opposed to the image of a planar mirror. (FIG. 11) shows the image as opposed to the object on a convex mirror whereby the crystal is in the shape of meniscus concave and turned upside down to appear to have a convex surface so these laws of refraction apply to this quartz crystal as obtaining the same optical behaviour as a mirror. A side view of the reflection of light on a concave mirror (See FIG. 12.A,B,C) The diagram show a side view of concave mirror (See FIG. 12) the principal axis, focal point (F), and center of curvature for both a concave spherical mirror (see FIG. 13) and the same for a convex spherical mirror (See FIG. 14). An external extremely strong power source is used to nuclear fuse the carbon, oxygen and neon atoms within the stellarator at the exactly calculated atomic and subatomic numbers of atoms is this atomic equation is crucial for the successful perfect fusion of all three elements. The laser light beam travels down into Stellarator where plasma is (See FIG. 2.I) and travels through the plasma down tube and into toroidal stellarator whereby perfect electromagnetic energy flows around infinitely (See FIG. 2.I) Due to the plasma having free electrons the laser light beam is energised as with plasma. The temperature and pressure used to fuse the two gases are yet to be determined. The confinement mechanism is stellarator and helical coils wrapped around torus of stellarator. There are two copper cables used, each 5 cm in diameter (See FIG. 1.J) one transfer sound waves and microwaves down centre tube (See FIG. 1L) to join the infinite wave in the form of the laser light beam, and this cable is soldered with silver and magnesium to clear quartz crystal and is positioned down centre tube. (See FIG. 1L) The other copper cable is soldered to inside of tube and goes upwards into an autotransformer (See FIG. 1.J) where the current is split into two currents. The leg one of autotransformer's current is used for all of our energy needs and leg two is transferred into a transducer (See FIG. 1.K) whereby the current is transferred into sound waves and this is used for communications. The leg one current goes into a jfet transistor (See FIG. 1.H) and leg two or sound waves goes into an nmos transistor. (See FIG. 1.K) These two transistors are positioned either side of crystal. (See FIG. 1.H).

### The Clear Quartz Crystal

The dimensions of the clear quartz crystal are 1 sqm in diameter and in the optical shape of meniscus concave. Using optical spectroscopy to ensure exact optical shape of crystal. There is a copper cable 5 cm in diameter soldered with silver and magnesium to right hand side edge of crystal and is joined to inside of centre tube of stellarator. This copper cable transfers the sound waves and microwaves down into centre tube of stellarator.

### Planar Mirrors

There are 3 planar mirrors and each is 1 sqm in area. These mirrors are positioned at right angles and above clear quartz crystal. These mirrors are silvered.

### Spherical Concave Mirror

This mirror is butted up to and underneath clear quartz crystal. The mirror is 1 sqm in diameter. This mirror is also silvered.

### Solar Collector Plate

The solar collector plate is positioned underneath arranged planar mirrors.

### Autotransformer, Transducer and Transistors

The autotransformer splits the electromagnetic energy extracted out of stellarator, via copper cable 5 cm in diameter, into two loads of electromagnetic energy. First load goes into a jfet field effect transistor, which is used for energy supply, and second load travels into a transducer which converts this energy back into sound waves for our communications and this is transferred into an nmos transistor with waffles transistors attached to it. These two transistors act as switches.

### Neon, Carbon and Oxygen

The reason neon, carbon and oxygen were used for fusion in this invention is due to this scientific relative facts in regards to these elements. The impact of stellar nuclear fusion on the elements in our universe is apparent. The most abundant elements after hydrogen and helium, which were created in the early expanding universe, are oxygen, an end product of helium fusion, neon, another end product of helium fusion, nitrogen, an element created from oxygen and carbon during hydrogen fusion, and carbon, the initial end product of helium fusion. This observational result is a consequence of the expulsion of gases by stars as they evolve. These fusion products mixed into the interstellar gasses influences the subsequent evolution of stars created from these gases. In this way, each generation of star influences the next generation. The fusion products created by the first stellar generation prepared the universe for life by creating carbon and oxygen. Refer claim 2.

### Neon

Of all the rare gases, the discharge of neon is the most intense at ordinary voltages and currents. It is present in the atmosphere as 1 part in 65000. Liquid neon has over 40 times more refrigerating capacity than liquid helium, and more than 3 times that of liquid hydrogen.

Here is a brief summary of the isolation of neon.

Neon is present to a small extent in the atmosphere Here is a brief description of neon and to why it was used

Standard state: gas at 298 K

Colour: colourless

Classification: Non-metallic

### Availability:

Neon does not react with air, even under extreme conditions.

Neon does not react with water. It does, however, dissolve slightly to the extent of about 10.5 cm³ kg⁻¹ at 20° C. (293 K)

Neon has a dielectric cohesion of 6.3 being the lowest of any gas, meaning an electric current can flow through it.

### CO2 Properties

Carbon dioxide (CO2) is a slightly toxic, odourless, colourless gas with a slightly pungent acid taste.

Carbon dioxide is a small but important constituent of air. Its typical concentration is about 0.038% or 380 ppm.

The oceans hold much of the earth's total CO2 and the oceans contain about 50 times more CO2 than the atmosphere.

Carbon dioxide will not burn or support combustion. CO2 gas is 1.5 times as heavy as air, thus if released to the air it will concentrate at low elevations.

Carbon dioxide is versatile because of its reactivity, inertness and coldness.

Carbon dioxide is used for refrigeration and cooling.

Carbon dioxide also prevents oxidation of metals. It absorbs atmospheric air.

Carbon has the atomic No of 6

The main use of the CO2 in this Energy Generator is to cool the otherwise high temperature of the plasma.

### Total Reflection

If the sun is at midday it is directly above in the sky. The 3 planar mirrors are positioned and they are the same dimensions and perfectly arranged together.

The incident rays from the sun and onto the planar mirrors are all equal and reflect upon each other perfectly forming the phenomena known as total reflection. The phenomena of total external reflection are when a beam is incident on a surface of the 3 planar mirrors at an angle which exceeds the critical angle. Refer Claim 3.

The rays then refract inwards to the focal point of the crystal and due to the spherical concave mirror being closer to the crystal than its own mirror image the light beam from focal point is virtual through and behind the spherical concave mirror passing at the focal point, which is the centre of the curve, of this mirror perfectly and down into the tube of nuclear fused neon and CO2.

### Reflected Rays

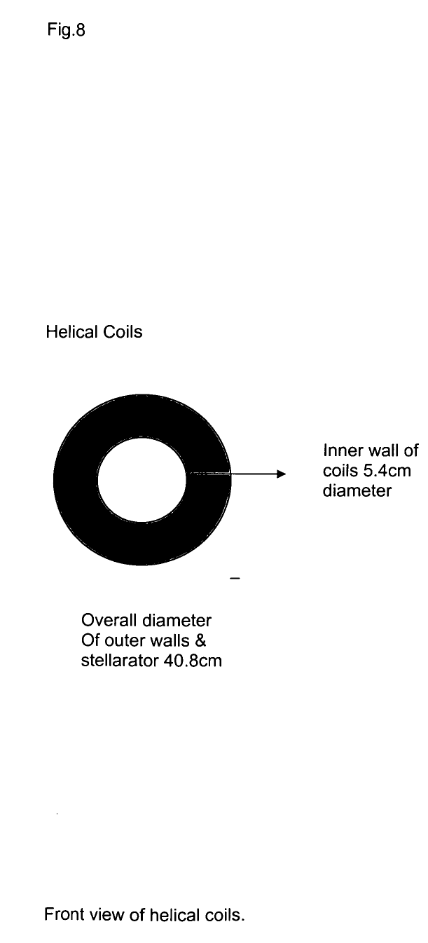

Reflected light obeys the law of reflection, that the angle of reflection equals the angle of incidence. See FIG. 8.

For objects such as mirrors, with surfaces so smooth that any hills or valleys on the surface are smaller than the wavelength of light, the law of reflection applies on a large scale. All the light traveling in one direction and reflecting from the mirror is reflected in one direction; reflection from such objects is known as specula reflection.

Most objects exhibit diffuse reflection, with light being reflected in all directions. All objects obey the law of reflection on a microscopic level, but if the irregularities on the surface of an object are larger than the wavelength of light, which is usually the case, the light reflects off in all directions.

### Planar Mirrors

A planar mirror is simply a mirror with a flat surface. Images produced by planar mirrors have a number of properties, including:
1. the image produced is upright
2. the image is the same size as the object (i.e., the magnification is m=1)
3. the image is the same distance from the mirror as the object appears to be (i.e., the image distance=the object distance)
4. the image is a virtual image, as opposed to a real image, because the light rays do not actually pass through the image. This also implies that an image could not be focused on a screen placed at the location where the image is.

### Optics

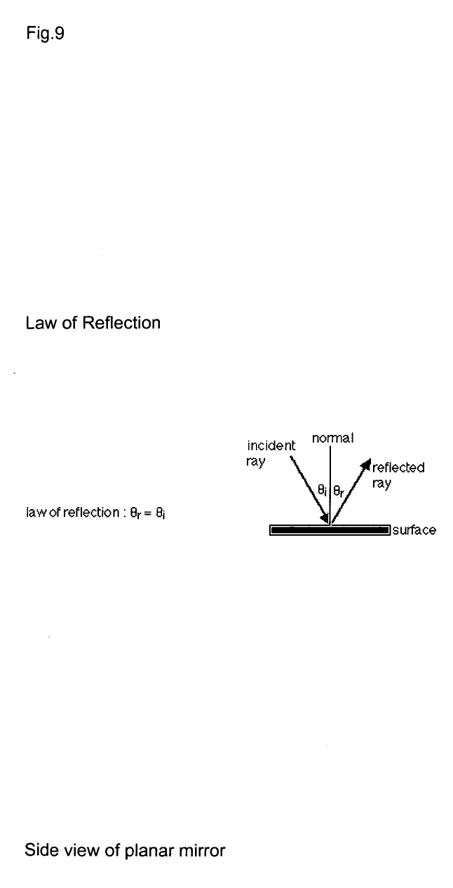

Dealing with light in terms of rays is known as geometrical optics, all based on similar triangles, but see FIG. 9 for a planar mirror.

Consider an object placed a certain distance in front of a mirror, as shown in FIG. 9. A ray diagram is used to show where the image of this object is located. In a FIG. 9, rays of light are drawn from the object to the mirror, along with the rays that reflect off the mirror. The image will be found where the reflected rays intersect. Note that the reflected rays obey the law of reflection. The reflected rays diverge from the mirror; they must be extended back to find the place where they intersect, and that's where the image is. See FIG. 9.

### Spherical Mirrors

Light reflecting off a flat mirror is one thing but when light reflects off a curved surface. Such as the spherical mirror, using reasonable approximations, this analysis is fairly straight-forward. The image you see is located either where the reflected light converges, or where the reflected light appears to diverge from.

A spherical mirror (See FIG. 13,14) is simply a piece cut out of a reflective sphere. It has a center of curvature, C, which corresponds to the center of the sphere it was cut from; a radius of curvature, R, which corresponds to the radius of the sphere; and a focal point (the point where parallel light rays are focused to) which is located half the distance from the mirror to the center of curvature. The focal length, f, is therefore:

Focal length of a spherical mirror: f=R/2

The spherical concave mirror used produces the laser light beam virtually meaning the laser light beam diverges through the focal point of spherical concave mirror due to the focus of laser light beam being the focal point of the clear quartz crystal which is perfectly positioned to diverge through the focal point of spherical concave mirror at the exact same line of virtual divergence through and behind spherical concave mirror making the laser light beam diverge negatively through the focal point of spherical concave mirror. (See FIG. 13). The object is between F and the mirror the image will be behind the mirror, making it a virtual image, and it will be upright compared to the object and this is the reason why the laser is virtual behind spherical concave mirror because the laser is closer to the mirror than its own mirror image thus the laser diverges to behind the mirror as if passing through the focal point of mirror which is the centre of curvature.

### The Mirror Equation

A ray diagram is a way to express what the image of an object is, and where the image is located. We can also calculate these things precisely, using something known as the mirror equation. The equation is, using the geometry of similar triangles.

The mirror equation:

1/d₀+1/dᵢ=1/f

where d₀ is the distance from the mirror to the object, dᵢ is the distance from the mirror to the image, and f is the focal length of the mirror.

### Magnification

In most cases the height of the image differs from the height of the object, meaning that the mirror has done some magnifying (or reducing). The magnification, m, is defined as the ratio of the image height to the object height, which is closely related to the ratio of the image distance to the object distance:

magnification:

m=hᵢ/h₀=−dᵢ/d₀

A magnification of 1 (plus or minus) means that the image is the same size as the object. If m has a magnitude greater than 1 the image is larger than the object, and an m with a magnitude less than 1 means the image is smaller than the object. If the magnification is positive, the image is upright compared to the object; if m is negative, the image is inverted compared to the object.

### Positive and Negative Images

The side of the mirror where the object is to be the positive side. Any distances measured on that side are positive. Distances measured on the other side are negative.

f, the focal length, is positive for a concave mirror, and negative for a convex mirror.

When the image distance is negative, the image is behind the mirror, so the image is virtual and upright.

A negative m means that the image is inverted. Positive means an upright image.

The positioning and dimensions (which are 1 sqm in area)×3 and a spherical concave mirror (1 m in diameter) positioned underneath the clear quartz crystal. See FIG. 3 The 3 square mirrors are positioned, two facing each other and the third at the top facing inward and down onto the crystal. The laser beam refracts inward to the focal point of the crystal, which is the centre of the curve, and because the spherical concave mirror positioned underneath the crystal is closer to the mirror than its own mirror image the laser beam then is virtual and passes through the spherical concave mirror at its focal point, the centre of the curve, and is then behind the mirror and down the tube filled with the neon and CO2 plasma.

The laser light beam is what charges the plasma due to plasma having free electrons. These free electrons become charged.

### Laser

Lasers amplify light and produce coherent light beams, ranging from infrared to ultraviolet. A light beam is coherent when its waves, or photons, propagate in step with one another. Laser light, therefore, can be made extremely intense, highly directional, and very pure in color (frequency).

The laser beam is a monochromatic wave meaning all the electromagnetic spectrum is one wavelength and whitish blue in colour. The laser light is spatially coherent, which means the crests and troughs of each light wave in the beam coincide with every other light wave and it is also coherent light and the waves do not radiate independently they reinforce each other.

The laser also carries thousands of communications simultaneously and this is why it pertained communications and will be used as a communications medium.

### Principles of Operation

Lasers harness atoms to store and emit light in a coherent fashion. The electrons in the atoms of a laser medium are first pumped, or energized, to an excited state by an energy source which in this case is concentrated electromagnetic radiation from the Sun. They are then “stimulated” by external photons to emit the stored energy in the form of photons, a process known as stimulated emission. The photons emitted have a frequency characteristic of the atoms and travel in step with the stimulating photons. These photons in turn impinge on other excited atoms to release more photons. Light amplification is achieved as the photons move back and forth between two parallel mirrors, triggering further stimulated emissions as in this invention. The intense, directional, and monochromatic laser light finally leaves through one of the mirrors, which is only partially silvered.

### Particle Model

In the particle model of EM radiation, a wave consists of discrete packets of energy, or quanta, called photons. The frequency of the wave is proportional to the magnitude of the particle's energy. Moreover, because photons are emitted and absorbed by charged particles, they act as transporters of energy.

As a photon is absorbed by an atom, it excites an electron, elevating it to a higher energy level. If the energy is great enough, so that the electron jumps to a high enough energy level, it may escape the positive pull of the nucleus and be liberated from the atom in a process called ionization. Conversely, an electron that descends to a lower energy level in an atom emits a photon of light equal to the energy difference. Since the energy levels of electrons in atoms are discrete, each element emits and absorbs its own characteristic frequencies which in this case is a singular and definate frequency unique to the quartz crystal.

Together, these effects explain the absorption spectra of light.

Frequency has an inverse relationship to the concept of wavelength. The frequency f is equal to the speed v of the wave divided by the wavelength λ of the wave:

### Clear Quartz Crystal

The clear quartz crystal was used because of its unique property whereby it is capable of generating laser light beams because of pleochroism, which means quartz crystals vibrate light in different crystallographic directions and may be differently absorbed. Different colours are; produced because in different directions vibration change. The quartz crystal also has piezoelectric qualities as electrical charges are set up across the certain of the crystalline faces.

Piezoelectricity is the ability of crystals to generate a voltage in response to applied mechanical stress. The word is derived from the Greek piezein, which means to squeeze or press. The piezoelectric effect is reversible in that piezoelectric crystals, when subjected to an externally applied voltage, can change shape by a small amount. (For instance, the deformation is about 0.1% of the original dimension in PZT.) The effect finds useful applications such as the production and detection of sound, generation of high voltages, electronic frequency generation, microbalance, and ultra fine focusing of optical assemblies

The quartz crystal also has a sound wave vibration due to the electromagnetic waves and due to its shape, which is meniscus concave turned upside down to appear to have a convex surface, the sound wave is spherical and twists at the highest point of vibration which is the focal point of crystal and it spreads out to the outer perimeters of crystal. This gives the shape of infinite ∞ to the wave and thus is how the infinite wave is created. Thus obeying Hooke's law which is Stress=C×Strain.

Where “C” is the elastic modulus of the material and particular strain involved.

### Chemical Properties

Clear Quartz is pure, or nearly pure Silicon Dioxide (SiO2), made of Silicon and Oxygen, the Earth's most common elements. Quartz has also been found in meteorites and moon rooks.

Quartz is one of the most common compounds in the Earth's Crust and one of its most useful. Throughout history, it had gemstone, spiritual, ornamental and collecting uses. Clocks, watches and computers. Its piezo-electric properties make it highly useful in modern technology, because in electric tests, it was shown to produce regular electric pulses and field changes. As the technology for creating synthetic Quartz evolved, they began using it to regulate the frequency of electronic devices. It was the first crystal used in radio wave transceivers, is used in watches and timepieces, and was essential in the development of computers.

Quartz is a power stone. It has been called the “Universal Crystal”, and is the most recognized type of crystal. Visual clarity normally isn't important to a quartz crystal's energetic quality and ability to amplify subtle energies.

Quartz enhances energy by absorbing, storing, amplifying, balancing, focusing and transmitting. It channels universal energy. Quartz also enhances thoughts, as they are a form of energy. Because it directs and amplifies energy, it is extremely beneficial for manifesting, healing, meditation, protection, and channeling. It is also beneficial for storing and retrieving information of all types, as information is a form of energy pattern also. This makes them particularly good for programming. Due to its ability to balance, quartz is excellent for harmonizing and balancing one's environment. Quartz is also good for energizing other crystals.

Quartz is a stone of clarity which dispels negativity and clears away negative energy. It can be used to purify and clarify on the spiritual, mental, and physical planes. It is also powerfully protective. Quartz enhances spiritual growth, spirituality and wisdom. Because it clarifies though processes and emotions it increases inspiration and creativity. It can also help particularly with concentration, studying, and retaining what one learns. Quartz is also a stone of harmony because it balances energies.

Psychically, quartz is a powerful stone. It is used for protection because it counters black magic and protects from negative energy. Quartz is very useful on the third eye chakra for clarity of psychic vision, and can be used to communicate with spirits and other worlds. Quartz is a stone that can access ancient wisdom and bring it into the present.

### Particle Displacement

This is a longitudinal wave of pressure (such as sound), but it can also be a transverse wave, in this case is both as it is a transverse wave in the crystal and also a longitudinal wave due to the plasma. In the case of a sound wave travelling through air, the particle displacement is evident in the oscillations of air molecules of air in and against the direction in which the sound wave is travelling with the speed of sound (though travels at the speed of infinite through stellarator).

### Speed of Propagation

Any electric charge which accelerates, or any changing magnetic field, produces electromagnetic radiation. Electromagnetic information about the charge travels at the speed of light before it is transferred through the crystal and then at the speed of infinite ∞ around stellarator. Refer Claim 4 and 6. Accurate treatment thus incorporates a concept known as retarded time (as opposed to advanced time, which is unphysical in light of causality), which adds to the expressions for the electrodynamic electric field and magnetic field. These extra terms are responsible for electromagnetic radiation. When any cable conducts alternating current, electromagnetic radiation is propagated at the same frequency as the electric current. Depending on the circumstances, it may behave as a wave or as particles. As a wave, it is characterized by a velocity (the speed of light), wavelength, and frequency. When considered as particles, they are known as photons, and each has an energy related to the frequency of the wave given by Planck's relation E=hv, where E is the energy of the photon, h=6.626×10⁻³⁴ J·s is Planck's constant, and v is the frequency of the wave. Waves travel at the speed of infinite in this case which is relative due to the unique shape of quartz crystal transferring the wave speed from the speed of light to the wave speed of infinte. Refer Claim 4.

In a medium (other than vacuum), this stellarator is not a vacuum, velocity of propagation or refractive index are considered, depending on frequency and application. Both of these are ratios of the speed in a medium to speed in a vacuum. The speed in a medium, being the quartz crystal, is changed due to quartz crystal properties afore mentioned and the new wave speed is infinite. Refer Claim 5.

The speed of sound is 343 m/s at 20° C. This invention has altered the natural speed of sound to infinite speed of sound. Refer Claim 4 and 5.

There is a copper cable soldered to crystal by silver and magnesium and is joined to the tube and this is how the sound waves and microwaves are transferred down the tube of stellarator and joined with laser light wave which is the perfect infinite wave ∞.

Another copper cable is soldered by silver and magnesium from the tube and into autotransformer.

An autotransformer is used to split the current into two loads of electromagnetic energy. One leg going into a JFET transistor, which is the power, and the other leg going into a transducer whereby the current is then transferred back into sound waves and enters into a NMOS transistor for our communications. Refer Claim 8.

1. Firstly 3 planar mirrors are positioned above reversed meniscus concave clear quartz crystal and reflect totally the complete electromagnetic spectrum, radiation.

2. The angle of incidence of complete electromagnetic spectrum, radiation exceeds the critical angle thus causing the phenomena total reflection of the rays.

3. The completely reflected rays refract into the focal point of clear quartz crystal being the centre of the curve and forms a piercing focus of light.

4. The unique frequency (vibration) of the clear quartz crystal creates a sound wave vibration and the electromagnetic waves and sound waves vibrates outward to cover the outer perimeters of surface of crystal.

5. The electromagnetic waves and sound waves compress into a singular wave with a binding twist which is formed at the focal point of crystal being the highest point of vibration.

6. The result of claim 5. is the infinite wave being the shape of infinity.

7. The infinite wave has a single wavelength, a single frequency described in theory of infinite wave claim 22.

8. The laser light beam is virtual and travels through the focal point of spherical concave mirror which is butted up against clear quartz crystal and due to the laser light beam being closer to the focal point of mirror than its own mirror image this results in laser beaming through focal point of mirror.

9. Neon, oxygen and carbon were used due to there unique energy properties and being products of the earliest helium fusion and all contain the same energy produced from that first helium fusion and these chemical elements, neon, carbon and oxygen created earth.

10. The chemical elements are scientifically proven in the nature of the universe to be a perfect fusion for earth's energy.

11. These elements are earth. and the energy of these elements are perfect in our atmosphere in there natural state

12. Perfectly matched atomic numbers for fusion and the energy and natural occurrence of relevance to the big bang and the second chemical element produced from that, being helium, formed energy that created life.

13. To fuse neon, carbon and oxygen back together would be the first and only natural fusion for perfect ambient temperature plasma.

14. That energy is pure and to be a natural resource for earth. It is simple and it just is. This is a further theory belonging to me and I can prove it what's more.

15. The fusion of these two gases (actually three components of gases) two being 1 carbon atom, atomic no. 6, to 2 oxygen atoms, atomic no. 8 and 1 neon atom, atomic no. 10 so therefore 1 no. 10 plus 1 atomic no. 6 is equal to 2 atomic no. 8 and matches in there atomic and subatomic numbers to create a perfectly matched fusion of the three chemical elements being 16+16 electrons, protons and neutrons and the end result is referred to in claim 1 and is a natural fusion process as all three elements are a result of the first stellar nuclear fusion which was the beginning of our universe, the most abundant elements after hydrogen and helium, which were created in the early expanding universe, are oxygen, an end product of helium fusion, neon, another end product of helium fusion, nitrogen, an element created from oxygen and carbon during hydrogen fusion, and carbon, the initial end product of helium fusion therefore it would be going with universal laws of physics to nuclear fuse neon and carbon and oxygen whereby neon is used in this invention due to its qualities whereby it emits light and light can travel through it and co2 is a natural refrigerant, in fact both gases are so after the fusion burn, due to an extremely powerful energy source to create the fusion, the plasma will cool very quickly and then will super conduct at ambient temperatures being the first superconductor to do so.

16. The laser light beam is formed due to the positioning of planar mirrors resulting in total reflection of electromagnetic radiation therefore waves and the positioning and optical shape of clear quartz crystal and the unique properties of crystal whereby the crystal forms the laser from the focal point of crystal and the spherical concave mirror that the crystal is butted up against is where the laser light beam is closer to mirror than its own mirror image resulting in laser going virtually behind focal point of mirror and into centre tube of stellarator igniting plasma with light quanta within the laser beam and due to neon emitting all light that flows through it and the light is the energy source.

17. The electromagnetic waves travel at the speed of light and sound waves travel at the speed of sound naturally though in this invention both electromagnetic waves and sound waves are transformed into a singular infinite wave with one wavelength and travel at infinite wave speed and there has been no prior art that claims this.

18. Sound waves are joined to electromagnetic waves (now laser light beam) by optical vibration of clear quartz crystal and due to the shape of the surface of the crystal and the unique frequency of the clear quartz crystal the sound wave is capable of vibrating the light waves and light quanta and particles within the electromagnetic waves to vibrate into a spreading spherical sound wave with the highest point of vibration being the focal point of the spherical crystal where the light due to the total reflection off the three planar mirrors and the intensity of light in the focal point of crystal where the laser is formed due to the extreme intensity of the focus of the light beams the spherical sound wave vibrates into a twist in the centre of the spherical sound wave which is the highest point of vibration and both light quanta and sound waves join into the wave shape of ∞ which is the formation of the infinite wave where the frequency of the infinite wave is a vibrational form due to spherical clear quartz crystal surface and pleochroism whereby clear quartz crystals modulate light beams and intensify the light beams and vibrate the light into directions being the claim of the infinite wave.

19. The unique vibration of the infinite wave and frequency of infinite wave carries the infinite wave through and around the torus of stellarator at infinite speed and being the toroidal shape of stellarator; the infinite wave flows infinitely around stellarator and produces an infinite supply of electromagnetic energy.

20. Three layers of metals are used to create stellarator and the outer layer is stainless steel for durability and tensile strength, second layer is the alnico group for superior magnetism and interior layer is made of silver due to it reflecting 95% of light and so the lasing infinite wave is permanently in place due to perfect reflection back onto itself so never altered.

21. Infinite wave is transferred into an autotransformer where it is split into two legs and the first leg is for energy supply and the second leg is used to transfer infinite wave back into sound waves by the use of a transducer and sound waves are used for communications.

22. THEORY
Frequency of waves travelling in the tube of the superconductor has an infinite frequency and it has an infinite current.
The equation
$$f = {c}^{∞}$$
$$for$$
$${p}^{∞} = \frac{{c}^{∞}}{D} 1 \text{K}$$
$$where$$
$$E = \frac{hv 2}{pv 2}$$
$$then$$
$$\frac{{c}^{∞}}{λ} pv = {I}^{∞} = \frac{{V}^{∞}}{{R}^{∞}}$$
Where the frequency f is equal to infinite wave speed c∞ for infinite particle displacement p∞ which equals infinite wave speed c∞ over distance of 1 km where energy is equal to quantum of light with velocity of particles moving in two loops corresponding to the same wave then the infinite wave speed c∞ of the wavelength of the particle velocity pv then infinite current l∞ is equal to infinite potential V∞ over infinite resistance R∞ sin equals −∞− cos −∞−.

23. Laser light beams have the capability of carrying thousands of communications simultaneously and in this invention the communications are carried directly from the universe. A. All communications via satellites and our outer atmosphere and beyond is capable of reaching earth via this unique infinite laser light beam. The communications contained in this laser light beam are so perfect that you could communicate throughout the universe with its universal communications in transmitting and receiving of communications through the infinite wave. Infinite universal communications.
